(19) United States
(12) Patent Application Publication
(10) Pub. No.: US 2022/0407901 A1
(43) Pub. Date: Dec. 22, 2022

(54) DYNAMIC AUDIO-BASED ONLINE COLLABORATION SYSTEM AND TOOLS

(71) Applicant: Team Orb Connect, Inc., Austin, TX (US)

(72) Inventors: Matthew Heagerty, Austin, TX (US); Aaron Upshaw, Austin, TX (US)

(73) Assignee: Team Orb Connect, Inc., Austin, TX (US)

(21) Appl. No.: 17/562,180

(22) Filed: Dec. 27, 2021

Related U.S. Application Data
(60) Provisional application No. 63/212,524, filed on Jun. 18, 2021.

(51) Int. Cl. H04L 65/403; H04L 12/18; G06F 3/0482; G06F 3/0484

(52) U.S. Cl. CPC H04L 65/403; H04L 12/1822; G06F 3/0482; G06F 3/0484

(57) ABSTRACT

Computer-implemented systems, methods and storage devices for online collaboration. An audio-based collaboration system includes an application having a connect cluster controller and a connect cluster user-interface (UI) element. The application enables a user to control online audio collaboration between other users in a group including which conversation in the group of users the user wishes to participate in accordance with one or more control inputs selected by the user on the connect cluster UI element through a user-interface. The connect cluster UI element includes a cluster of selectable regions, each selectable region corresponds to a respective user in the group of users. A collaboration manager manages collaboration between groups of users as part of a remote cloud computing service.

This application claims the benefit of priority to provisional application No. 63/212,524, filed Jun. 18, 2021, incorporated by reference in its entirety herein.

### BACKGROUND

### Technical Field

The field relates to online conferencing and collaboration.

### Background

Online communication is increasingly desired between groups of users over data networks. A number of different online conferencing tools allow remote users to carry out audio and/or video communication. For example, online conferencing tools such as Google HANGOUTS, Microsoft TEAMS, Cisco WEBEX CONNECT, and ZOOM, allow groups of users to set up and host meetings where audio and video communication between users may occur. Some tools allow a user or host to mute or unmute, adjust volume, or to leave a set meeting.

However conventional online conferencing tools have a number of drawbacks and limitations that prevent effective collaboration between a team of users. These tools require a group of users to be identified and invited to a meeting in advance according to a predetermined schedule. In such cases, other team members not originally invited may not be aware of a meeting or be able to easily join. Also existing conferencing tools are often host driven in that only a host may control subdivision of participants into breakout rooms or subgroups and even then only after a group has been invited to the meeting. Individual users cannot dynamically enter or join a group conversation easily and cannot easily configure themselves into separate conversations.

What is needed are online conferencing tools that overcome these limitations and drawbacks.

### BRIEF SUMMARY

The present disclosure overcomes the above deficiencies and technical problems. The present disclosure provides new computer-implemented systems, methods and storage devices for online collaboration including a connect cluster user-interface (UI) element.

In an embodiment, an audio-based collaboration system is configured to enable a group of users to communicate over a data network with applications on remote computing devices accessed by users through user-interfaces. The audio-based collaboration system includes a connect cluster controller and a connect cluster UI element on a user application side and a collaboration manager on a remote cloud computing side. Collaboration manager manages which groups of users compose different teams. An application may include a connect cluster controller configured to generate and control a dynamic connect cluster UI element. Dynamic connect cluster UI element may be output in one or more display views of the application.

In a feature, the connect cluster UI element may include a cluster of selectable regions. Each selectable region corresponds to a respective user in a group of users, such as a team. In one embodiment, the cluster of selectable regions is a circular grouping of selectable regions about a central point, and each selectable region further comprises a circular shape. The connect cluster UI element may further include a control region at the central point that enables a user to input a control action.

In a further feature, the connect cluster UI element may also include dynamically selectable UI elements configured to display status or initiate control actions relating to managed audio streams between users.

In an embodiment, the connect cluster controller initiates a control action relating to audio conversation within the group of users in response to one or more user control inputs at the respective selectable region. The control action includes one or more of starting a conversation, joining a conversation, or adding to the conversation. Further control actions may include one or more of making a conversation private, leaving a conversation, muting a conversation, changing a user volume, muting a background conversation, or changing a background conversation volume.

In a further embodiment, a control action includes controlling entry to a conversation that may or may not be overheard. The connect cluster UI element includes a graphical indication of a door in either an open or closed configuration.

In further features, the connect cluster controller enables a user to move the connect cluster UI element within a display view. The connect cluster controller may also enable a user to select a menu of settings or input hotkey commands.

In an embodiment, a connection manager may be include a peer-to-peer connector configured to initiate peer-to-peer links carrying audio streams for conversation between computing devices.

In further embodiments, computer-implemented methods for enabling a group of users to control participation in online audio conversations through control inputs at user interfaces and non-transitory computer-readable storage devices are provided.

Further embodiments, features, and advantages of the invention, as well as the structure and operation of the various embodiments of the invention are described in detail below with reference to accompanying drawings.

### BRIEF DESCRIPTION OF THE FIGURES

Embodiments are described with reference to the accompanying drawings. In the drawings, like reference numbers may indicate identical or functionally similar elements. The drawing in which an element first appears is generally indicated by the left-most digit in the corresponding reference number.

FIG. 1 is a diagram of an audio-based online collaboration system according to an embodiment of the present invention.

FIG. 2 is a diagram of an application having a connect cluster controller according to an embodiment of the present invention.

FIG. 3 is a diagram showing a device having a display view with connect cluster user-interface element according to an embodiment of the present invention.

FIGS. 4A and 4B are flowchart diagrams showing a method for dynamically enabling a group of users to control participation in online audio conversations according to an embodiment of the present invention.

FIGS. 5-16 are images of user-interface elements and selectable regions that may be included with a dynamic connect cluster UI element according to embodiments.

### DETAILED DESCRIPTION

Embodiments of the present invention overcome the above-mentioned disadvantages. The inventor(s) recognized what is needed are systems and methods for improved audio-based online communication and collaboration over a network.

Embodiments refer to illustrations described herein with reference to particular applications. It should be understood that the invention is not limited to the embodiments. Those skilled in the art with access to the teachings provided herein will recognize additional modifications, applications, and embodiments within the scope thereof and additional fields in which the embodiments would be of significant utility.

In the detailed description of embodiments that follows, references to “one embodiment”, “an embodiment”, “an example embodiment”, etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to effect such feature, structure, or characteristic in connection with other embodiments whether or not explicitly described.

### Audio-based Online Collaboration System

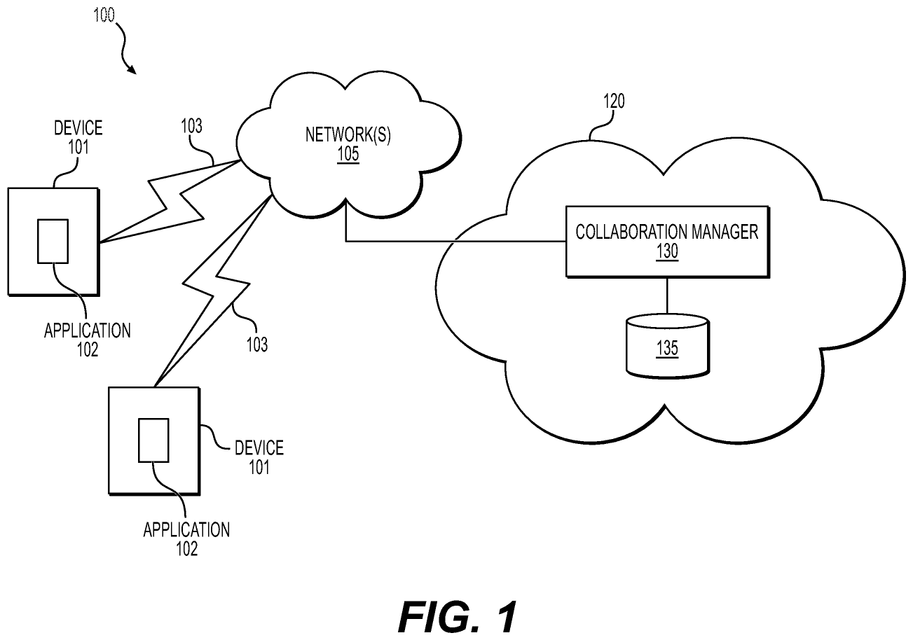

FIG. 1 is a diagram of an audio-based online collaboration system 100 according to an embodiment of the present invention. Audio-based collaboration system 100 includes one or more computing devices 101 coupled over communication links 103 to over one or more data networks 105 to a remote cloud computing service 120. Each computing device 101 may include an application 102. Remote cloud computing service 120 may include a collaboration manager 130 and one or more databases 135. Collaboration manager 130 is implemented on one or more processors and communicatively coupled to applications 102 over data network(s) 105.

Audio-based collaboration system 100 is configured to enable a group of users to communicate with one another over data network 105 with applications 102 accessed by users through user-interfaces. Collaboration manager 130 manages collaboration between groups of users of audio-based online collaboration system 100. Database 135 stores data relating to the online audio collaboration managed by collaboration manager 130 and supported by service 120. Each application 102 enables a user to control online audio collaboration between other users in a group. This control includes enabling a user to select through a user-interface which conversation in a team of users the user wishes to participate. Each application 102 may send and receive data and control information to and from collaboration manager 130. Each application 102 may also control connections for audio streams in which a user participates.

In an embodiment, collaboration manager 130 manages which groups of users compose different teams. This may include creating new teams, adding or removing users from teams, or deleting teams. Users may also switch teams in which case collaboration manager 130 updates team information for users indicative of the switch. Collaboration manager 130 may further manage status, availability, usage or other status or monitoring information relating to the groups of users and their conversations. Database 135 may store data records with data on the status, availability, usage or other status or monitoring information relating to the groups of users and their conversations.

Other functions (not shown) may be carried out by remote cloud computing service 120 such as user registration and authentication, billing, report generating and analytics. One or more application programming interfaces (APIs) coupled to collaboration manager 130 may be used to access other cloud computing services to carry out these other functions.

In one feature, audio-based online collaboration system 100 allows a user to have organic conversations with their teammates, whether one on one or as a group. Users can view other teammates currently with an online presence and immediately see whether they are available to engage in online conversation. Users can also overhear conversations that happen among teammates helping them stay in tune with another and fostering collaboration. A user may also choose to shut their door so the user will not overhear other conversations. A connect cluster user-interface (UI) element may be used having a compact and efficiently sized area within a display view. In this way, when multiple applications are running and screen space is limited, a user may still access application 102 and a connect cluster user-interface UI element to communicate and collaborate with teammates. Moreover, the design and operation of connect cluster UI element is such that it facilitates online conversations between teammates, such as overhearing and requesting entry to active conversations, in a more natural way like human-to-human interaction in a workplace or other setting.

In further features, users can join teams and the composition of the team can change. Teams can be private or public and can be temporary. A user can move between teams.

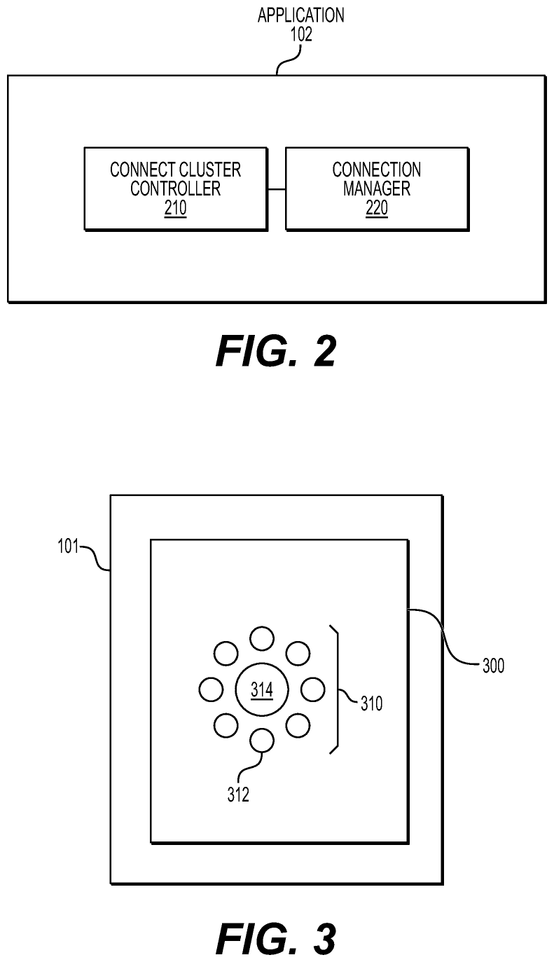

As shown in FIG. 2, in one embodiment, application 102 may include a connect cluster controller 210 and connection manager 220. Connect cluster controller 210 manages operation of a respective connect cluster user-interface (UI) element. Connection manager 220 controls connections between remote devices 101 for audio streams in which a user participates. In one feature, not necessarily intended to be limiting, connections may be peer-to-peer connections between devices 101. In this way, connections of audio streams between users in conversation may be managed by devices 101 reducing the computing demand on remote cloud computing services 120 and increasing the scalability of service 120 and collaboration manager 130 to manage more teams of users.

As shown in FIG. 3, computing device 101 may include a display 300. Application 102 may output a display view (such as a window or panel) for display on display 300. In one feature, the display view on display 300 includes a connect cluster UI element 310. In one embodiment, not intended to be limiting, connect cluster UI element 310 includes a user-selectable main region 314 surrounded by a group of regions 312. For example, as shown in FIG. 3, main region 314 may be a circular shape surrounded by a group of regions 312 formed in a ring about main region 314. In this way, a compact arrangement may be obtained within the display view.

Users can initiate, join, or participate in conversations and perform other actions using application 102 and connect cluster UI element 310 as described in further detail below. For example, each selectable region 312 corresponds to a respective user in a group of users, such as a team. Text, color, images, or other graphical information may be displayed in a region 312 to identify a respective user. Main region 314 is a control region at a central point that enables a user to input a control action. Text, color, images, or other graphical information may be displayed in main region 314 to identify status, available control actions, or other pertinent information relating to user conversation in online collaboration system 100.

In an embodiment, connect cluster controller 210 initiates a control action relating to audio conversation within the group of users in response to one or more user control inputs at one or more selectable regions 312 or 314. The control action includes one or more of starting a conversation, joining a conversation, or adding to the conversation. Further control actions may include one or more of making a conversation private or leaving a conversation, muting a conversation, changing a user volume, muting a background conversation, or changing a background conversation volume.

In a further embodiment, a control action includes allowing a user to not overhear a conversation, make a conversation private or not private, or join a conversation. The connect cluster UI element 314 may include one or more graphical indications to facilitate a user's selection of a control action. These graphical indications for example may be of a closed door, or an open or closed lock. Different graphical indications may also be provided in different states. One state may include graphical indications that allow one to control the door state (such as a closed door) while another state may provide graphical indications or icons associated with in-conversation controls. These in-conversation controls may be graphical icons to lock/unlock, mute/unmute, or close conversation.

In one default example, all users in a cluster (teammates) can overhear active conversations between the users, that is, a user receives audio streams of the other users in conversation. A user however may choose to close his or her graphical door to not overhear conversation. When a user has a graphical door closed the user does not overhear conversations of other teammates and does not receive an audio stream of the conservations. In this way, the audio experience of users in a team is much like those having an actual conversation in a physical hallway where other users may choose to overhear the hallway conversation or may choose to close their door to not overhear the hallway conversation. In a further aspect, users may also make a conversation private (such as by selecting a graphical lock to place in it a locked configuration) in which case no other users can overhear the conversation. To join a private conversation, a user must be invited by a conversation participant to join.

In further features, connect cluster controller 210 may enable a user to move the connect cluster UI element 310 within a display view. The connect cluster controller 210 may also enable a user to select a menu of settings or input hotkey commands.

In embodiments, the term application (such as application 102) refers to an application, web application, browser, or browser extension. For example, application 102 may be configured as an application installed on computing device 101 or may be a web application operated through a browser or browser extension on computing device 101.

Application 102 may be implemented in software, firmware, hardware or any combination thereof on a computing device 101. Computing device 101 may run application 102 and communicate over data networks 105 including over the World Wide Web using web protocols or other communication protocols. Cloud computing service 120 including collaboration manager 130 may be implemented in software, firmware, hardware or any combination thereof and may be implemented on one or more computing devices at the same or different locations. Cloud computing service 120 may also be configured as a computer-implemented cloud-based platform supporting web-based services, data storage, user registration, application services, communications, or management functions. A computer-implemented platform such as a cloud-based, Software as a Service (Saas) and/or Infrastructure as a Service (Iaas) platform may be used in service 120. Applications 102 may be also configured on computing devices 101 at one or more locations may be coupled over one or more data networks 105, such as a local area network, medium area network or wide area network, such as the Internet, to the cloud-based platform. Web servers and World Wide Web protocols may be provided as part of the platform. Firewalls or other security mechanisms may be included.

### Operation and User Interface Elements

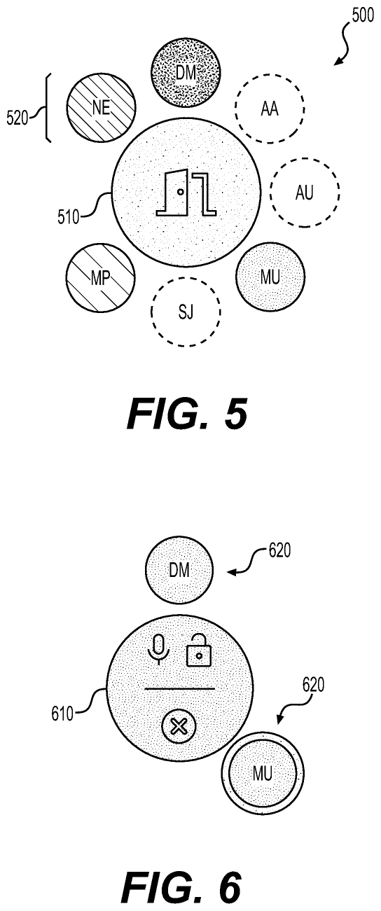

The operation of system 100 is described in further detail below with respect to method 400, and example user-interface elements in FIGS. 5-16.

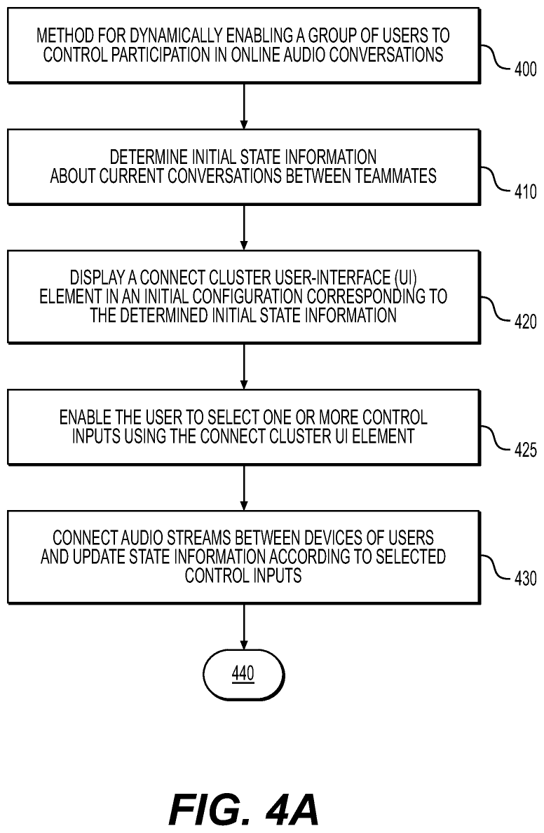

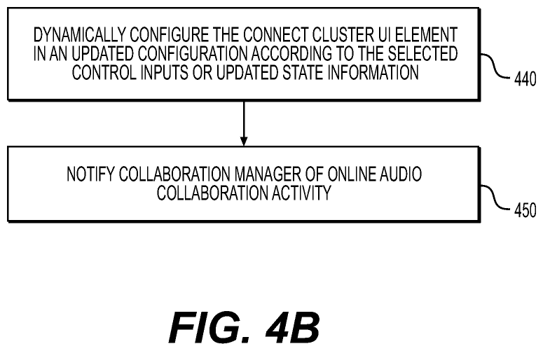

FIGS. 4A and 4B show a process 400 for enabling a group of users to control participation in online audio conversations through control inputs at user interfaces according to an embodiment of the present invention (steps 410-450). In an embodiment, steps 410-450 may be carried out by application 102. For example, steps 410-425 and 440-450 may be performed by connect cluster controller 210 and step 430 may be performed by connection manager 220. For clarity, operation will be discussed with reference to a first user who be interacting with application 102 through a user-interface provided on computing device 101 and one more display views displayed on a display 300.

In step 410 in FIG. 4A, connect cluster controller 210 determines initial state information about current conversations between teammates. The initial state information may include for example information identifying a group of users in the same team as the first user. The initial state information may further include presence information (i.e, whether a user is online or not or available to connect) and status information such as whether a user is engaged in active conversation. Further status information may include whether a conversation is private and whether a user has a closed door configuration.

In step 420, connect cluster controller 210 outputs a connect user-interface element in an initial configuration corresponding to the initial state information. For example, connect cluster controller 210 may cause a connect user-interface element 310 to be displayed having a main region 314 and one or more surrounding regions 312 according to the initial state information. The number of regions 312 equals the number other users in a team. The main region 314 can be associated with the first user. Each region 312 can be shaded or colored to indicate whether the respective user is engaged in an active conversation. Main region 314 also can be shaded or colored to indicate whether the respective user is engaged in an active conversation. Open or closed doors can be displayed within a region 312 or 314 to indicate whether a user has shut a door in a closed door configuration to avoid overhearing a conversation. Open or closed locks can be displayed within a region 312 or 314 to indicate whether a conversation is private (closed lock) or not private (open lock). Text such as user initials may be shown in each region 312, 314 to further help identify participating team members.

In step 425, the first user is enabled to select one or more control inputs on connect user-interface element 310. For example, the first user may use a user-interface to select one or the regions 312 and initiate an action with a teammate. This action may include, for example, initiating a new conversation, overhearing a conversation, inviting a teammate to join a conversation, or leaving a conversation. The first user may also select a portion of the connect user-interface element 310 to move it to different locations within a display view. The first user may also hover or right click to expand a region or make other command menus or control options appear.

Some selected control inputs in step 430 require an audio stream to be connected to device 101 for the first user to engage in an audio conversation. In step 430, connection manager 220 connects one or more audio streams to application 102 on device 101. For example, connection manager 220 many communicate with other applications 102 and establish peer-to-peer connections between devices of teammates. In this way, audio streams corresponding to selected conversations between teammates can be passed to and from device 101 of the first user and devices 101 of other teammates. Connection manager 220 connects one or more audio streams to applications 102 on devices 101 according to the state information and control managed by respective connect cluster controllers 210 so that users hear or do not hear audio in conversations between other users as described herein.

In step 440 in FIG. 4B, connect cluster controller 210 dynamically configures connect user-interface element 310 in an updated configuration according to the selected control inputs or updated state information. For example, one or more regions 312 may change their appearance to reflect changes in online presence, conversation status, or number of users in a team. Main region 314 may also change in appearance to reflect changes in online presence or conversation status. In this way, connect user-interface element 310 dynamically changes as teammates interact online and engage in online conversations with each other. The selected control inputs used to dynamically configure connect user-interface element 310 may be those input through a user-interface by a user. Updates to state information may also be received by application 102 from other applications 102 and from remote collaboration manager 130. Initial and updated state information may be stored in database 135 and on memory in device 101.

Finally, in step 450, connect cluster controller 210 notifies collaboration manager 130 of online audio collaboration activity. For example, messages having data may be sent to collaboration manager 130 in response to the first user activity. Messages may include data regarding relevant actions taken in response selected control inputs made through connect user-interface element 310 in step 430 or other updated status information. After step 450, control ends which may be when application 102 is closed or minimized.

The operation and advantages of audio-based online collaboration system 100 and method 400 are further described with respect to particular control actions that may be selected by a user.

FIGS. 5-16 show examples of user-interface elements and selectable regions that may be included with a dynamic connect cluster UI element for a team of users. FIG. 5 shows a dynamic connect cluster UI element 500 generated for a team of eight users (also called teammates). A main region 510 is associated with a first user (MH). Regions 520 (e.g. team dots) surround main region 510 and are associated respectively with seven other teammates. Initials of other teammates can appear in the respective regions 520.

### Start A Conversation

To start a conversation, one may simply click on a teammate's region 520. Hovering on main region 510 causes all of one team's regions 520 to appear. Each region 510 represents a teammate. Teammates who are signed in will appear as a color in a respective region 520. Teammates that are not signed in are greyed out. By default, unless their door is closed, a user may overhear all conversations occurring among teammates which are not private. If another teammate's door is closed, a user first needs to knock and be accepted by the other teammate to join. Once accepted, one will be connected in a conversation.

As shown in FIG. 6, when a user (represented by region 610) is in a conversation, the teammates (represented by regions 620) a user is talking to will remain visible, and regions 620 will all be the same color to indicate they are in the same conversation.

### Join A Conversation

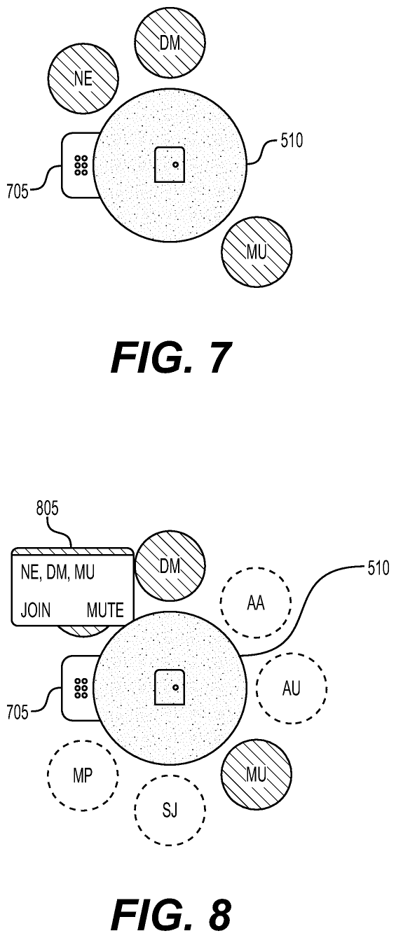

As shown in FIGS. 7 and 8, if another conversation is occurring among one's teammates and one has something to add, it is easy to be part of the conversation. FIG. 7 shows a conversation occurring between three teammates NE, DM, MU (which may all be shown in the same color to easily depict to users that the teammates are in the same conversation). (Tab 705 is also shown which will be described further below with respect to moving). Simply click the team dot of any teammate in the conversation, or hover over their dot and a panel 805 will appear as shown in FIG. 8. Click “Join” in the panel 805 and then one will be automatically entered in the conversation with the three teammates NE, DM, MU. Mute (or unmute) may be selected to mute (or unmute) oneself in a conversation. Teammates AA, AU, MP, and SJ may be shown greyed out to indicate they are not presently online.

### Add To The Conversation

Once a user is a conversation, it is easy to add other teammates. Clicking a user's respective region (also referred to as a user team dot) works exactly the same as starting a conversation. If a user's door is open, clicking will instantly add them to the conversation. If their door is closed, they'll join the conversation as soon as they accept the knock.

### Make A Conversation Private

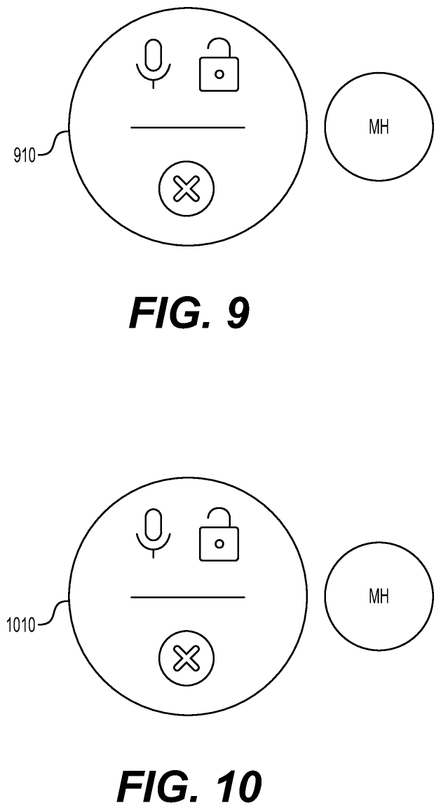

When a user is in a conversation, the main region 910, as shown in FIG. 9, changes from allowing one to control the door state to in-conversation controls. These in-conversation controls may be icons to lock/unlock, mute/unmute, or close conversation. Clicking the lock icon makes the conversation private. No team members outside a conversation will hear the user's conversation, and they are unable to join the conversation. The user can also add additional members to a private conversation by inviting them. Once a conversation has been made private, it will stay private until the conversation has ended.

### Leave A Conversation

As shown in FIG. 10, when one is in a conversation, main region 1010 changes from allowing one to control the door state to in-conversation controls (such as mute/mute button depicted with a microphone icon). Clicking the “X” close icon will remove the user from the conversation.

### Conversation Audio

A user can also control audio in a conversation through a connect cluster UI element.

### Mute Yourself

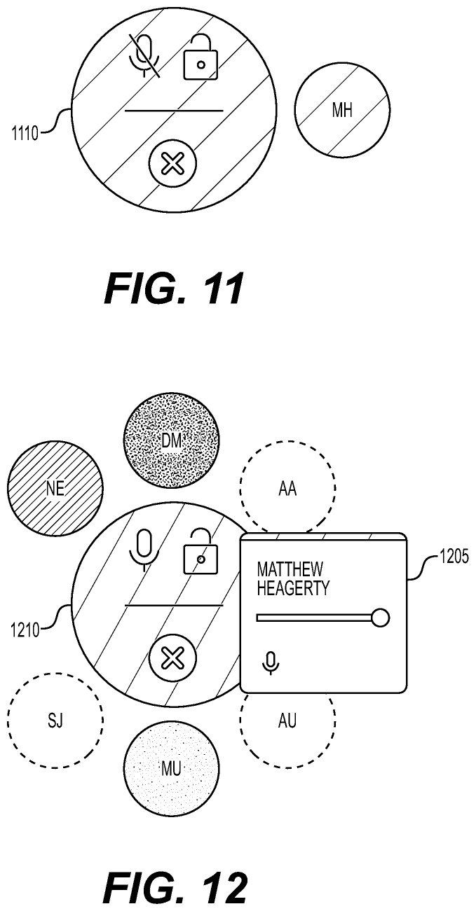

When a user is are in a conversation, as shown in FIG. 11, a main region 1110 changes from allowing a user to control the door state to in-conversation controls. Clicking the microphone icon will temporarily mute until a user clicks it again. Of course, while not shown, color may be added in each of regions 910, 1010 and 1110 above to indicate when a respective user is in engaged in conversation.

### Change Team Member Volume

When in a conversation, the volume of individual connections can be lowered. As shown in FIG. 12 having main region 1210, hovering over a teammate's region (team dot) will cause a panel 1205 or modal to appear that allows a user to change the volume for that team member. For example, panel 1205 may have a slider or dial to control volume level.

### Mute A Background Conversation

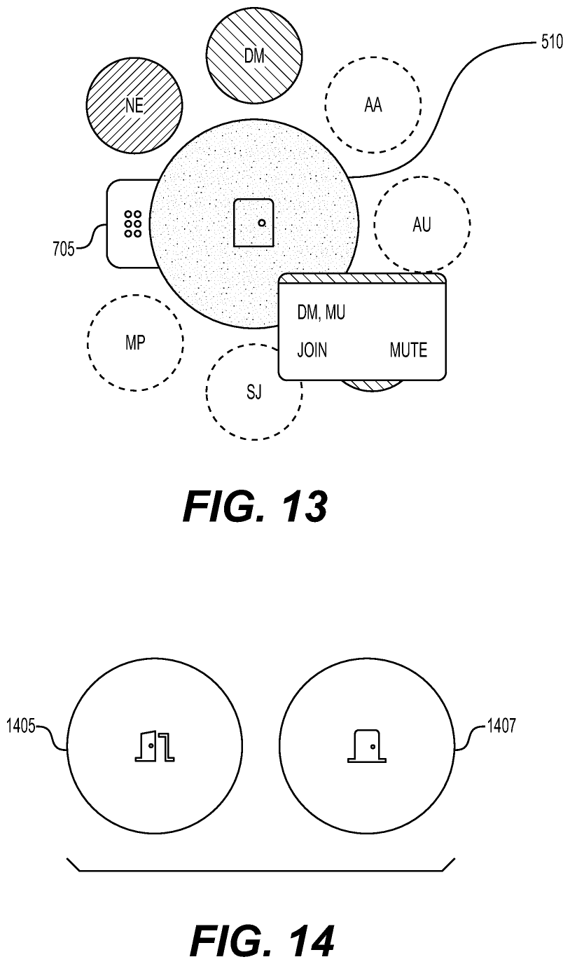

When background conversations are occurring, hovering over an active conversation causes a panel or modal to appear (as shown in FIG. 13) that allows one to mute or join the conversation. Joining a conversation mutes any other conversations.

### Change Background Conversation Volume

The door in a region may be set to either opened (region 1405) or closed (region 1407) as shown. The state of the door may be changed when not in a conversation by clicking on the Door icon.

### When the Door is Open

Teammates can start a conversation with a user (or overhear the conversation) instantly by clicking a user's region (team dot). If other teammates are in a conversation, one will overhear their conversation at a reduced background volume, just like in the office.

### When the Door is Closed

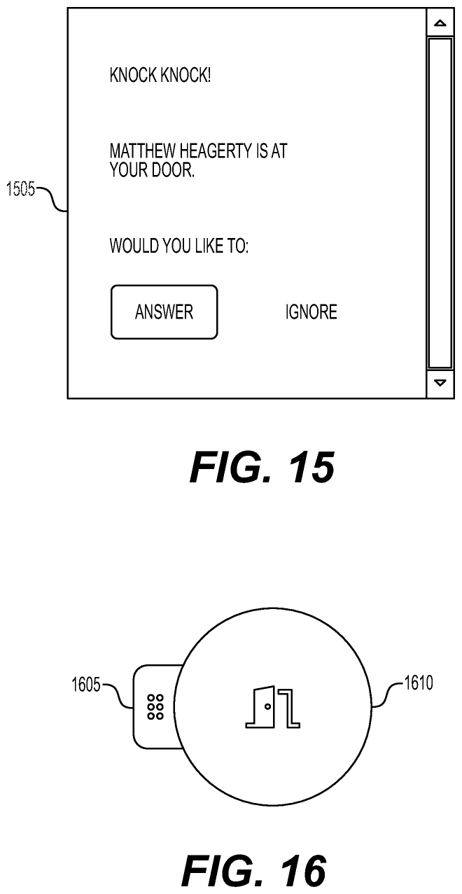

Teammates will have to knock to start a conversation with a user. When the door is closed and a teammate clicks a user's region (team dot), one is presented with a notification allowing one to answer or ignore the knock. The notification may appear as a window 1505 with buttons to answer or ignore the knock as shown in FIG. 15. If one does nothing, the knock will be dismissed on its own.

Note if other teammates are in a conversation, a user with a closed graphical door will not hear those conversations. A user can still see if other conversations are happening by hovering a mouse over regions in the connect cluster UI element.

### Moving The Connect Cluster

One can move the connect cluster UI element anywhere on his or her desktop. Clicking on the connect cluster UI element (region 1610) causes a grey tab 1605 to appear on the left as shown in the example of FIG. 16 (or tab 705 in FIG. 7). Left click and hold on the grey tab and enables a user to drag the connect cluster UI element wherever they want in a display view. Once the connect cluster UI element is placed where one wants, just let go of the tab and the connect cluster UI element will remain there. Tabs 705 and 1605 are optional. In other examples, tabs 705 and 1605 may be omitted. A connect cluster UI element may be moved anywhere on a desktop by selecting a non-interactive portion of connect cluster UI element. For example, a user with a mouse or trackpad device may left click and hold a non-interactive portion of connect cluster UI element and move the non-interactive portion of connect cluster UI element to a different location shown in a display view.

One advantage of eliminating a tab, is that is allows more space for an additional user to be present and represented in a conversation.

Also, with or without a tab, larger teams (i.e. more than 9 team members) may be accommodated by arrows that appear on the right and left of the connect cluster UI element. Online users are listed first (so if only 8 other team members were online, they would all appear on the first view of a connect cluster UI element). If more team members are online, then the arrows may be used to navigate to them or to see other team members that are not online.

In a further embodiment, an application or a connect cluster UI element may also include a user-interface control element that enables a user to select to share screen. When screen share is selected by a user, other participants in the conference then can view content shared by the user who elected to share screen.

### Settings

Settings may be accessed through a system menu included with application 102. In one example, not intended to be limiting, a user can right click on the connect cluster UI element for a menu to appear or a system menu may appear within a menu bar of application 102. In one example a settings menu (or submenu) has options to open/close door, as well as links for audio device settings and hotkey settings. A user can access further display panels or menus to set or adjust audio device settings and hotkey settings.

Audio device settings may include options to enable a user to microphone and speakers. A default selection is system audio, but the audio settings menu can allow one to change each device. System 100 (i.e., application 102) may remember a user's preferred devices and attempt to load them on restart. If the chosen devices are not available, system will default to system audio.

### Background Conversation Volume

Application 102 may also help a user stay up to date with a team and aids collaboration by letting a user hear conversations between teammates. If these conversations are too loud or too quiet, their volume can be adjusted under the Audio Settings. This adjustment may apply to all background conversations.

### Hotkeys

In an example, hotkeys may be provided. Application 102 may make global hotkeys available for common actions. Default hotkeys may be as follows:

| Action | Windows/Linux Shortcut | macOS Shortcut |
|---|---|---|
| Open Door | Ctrl + Shift + O | Command + Shift + O |
| Close Door | Ctrl + Shift + C | Command + Shift+ |
| Connect with | Ctrl + Shift + | Command + Shift + |
| Teammate | 1 . . . 2 . . . etc. | 1 . . . 2 . . . etc. |
| End Connection | Ctrl + Shift + E | Command + Shift + E |

Any of these default key combinations can be changed in the hotkeys settings menu.

### Further Examples and Advantages

Examples above refer to circular regions arranged in a cluster, however, this is illustrative and not intended to be limited as other shapes and layouts may be used.

Also a conversation as the term is used herein refers to at least audio between two users (1 to 1) or between multiple users (1 to N), where N is a number of users in a team. A user may also switch between teams.

In further embodiments, a conversation may include audio and video components of a conversation between users.

The embodiments and examples above are illustrative and not necessarily intended to be limiting. Other alternative embodiments are possible.

In an embodiment, application 102 may be controlled from a system menu, such as, a system tray or dock.

In a further embodiment, connect cluster UI element may be minimized and will automatically reappear when a conversation is initiated.

In a further feature, an additional “Announce” icon (e.g., a megaphone shaped icon) may be displayed. For example, the megaphone icon may be displayed next to a door icon to allow a user to announce to all online team members. The user's announcement will then be sent in audio streams to all online team members.

To further illustrate the interplay of users in a private conversation or with closed door configurations, here are further non-limiting examples of users A, B and C using system 100 in one embodiment. If user A has a closed door, then user B has to knock to start a conversation, and A has the option to accept/reject. If users A and B are in a conversation with each other, it does not matter whether their doors were open or closed when the conversation began (and there are no door controls once in a conversation). User C, who is not part of that conversation, will overhear the conversation between A and B if user C's door is open. If user C does not want to hear the conversation, user C can shut their door, or if user C's door was already shut, then they would not hear the conversation between users A and B. If users A and B (who are in a conversation) make the conversation private, which is accomplished by clicking the lock icon that is only present for a user when they are in a conversation, then user C will not hear that conversation, regardless of whether user C's door is open or closed.

### Further Embodiments

Aspects of the embodiments of system 100 including application 102 and its connect cluster controller 210 and connection manager 220, and cloud service 120 including collaboration manager 130 may be implemented electronically using hardware, software modules, firmware, tangible computer readable or computer usable storage media having instructions stored thereon, or a combination thereof and may be implemented in one or more computing devices or other processing systems.

Embodiments may be directed to computer products comprising software stored on any computer usable medium. Such software, when executed in one or more data processing device (also called a computing device), causes a data processing device(s) to operate as described herein.

Various embodiments can be implemented, for example, using one or more computing devices. A computing device (such as device 101) can be any type of device having one or more processors and memory. For example, a computing device can be a workstation, mobile device (e.g., a mobile phone, personal digital assistant, tablet or laptop), computer, server, computer cluster, server farm, game console, set-top box, kiosk, embedded system, or other device having at least one processor and memory.

Embodiments of the present invention have been described above with the aid of functional building blocks illustrating the implementation of specified functions and relationships thereof. The boundaries of these functional building blocks have been arbitrarily defined herein for the convenience of the description. Alternate boundaries can be defined so long as the specified functions and relationships thereof are appropriately performed. The breadth and scope of the present invention should not be limited by any of the above-described exemplary embodiments.

The foregoing description of the specific embodiments will so fully reveal the general nature of the invention that others can, by applying knowledge within the skill of the art, readily modify and/or adapt for various applications such specific embodiments, without undue experimentation, without departing from the general concept of the present invention. Therefore, such adaptations and modifications are intended to be within the meaning and range of equivalents of the disclosed embodiments, based on the teaching and guidance presented herein. It is to be understood that the phraseology or terminology herein is for the purpose of description and not of limitation, such that the terminology or phraseology of the present specification is to be interpreted by the skilled artisan in light of the teachings and guidance.

What is claimed is:

1. An audio-based collaboration system, comprising:
an application having a connect cluster controller configured to operate on a computing device accessed by a user;
a connect cluster user-interface (UI) element coupled to the connect cluster controller; and
a collaboration manager implemented on one or more processors and coupled to the application over a data network,
wherein the collaboration manager manages collaboration between groups of users, and
wherein the application enables a user to control online audio collaboration between other users in a group including which conversation in the group of users the user wishes to participate in accordance with one or more control inputs selected by the user on the connect cluster UI element through a user-interface.

2. The system of claim 1, wherein the connect cluster UI element includes a cluster of selectable regions, each selectable region corresponds to a respective user in the group of users.

3. The system of claim 2, wherein the connect cluster UI element further comprises dynamically selectable UI elements configured to display status or initiate control actions relating to the managed audio streams between users.

4. The system of claim 2, wherein the connect cluster controller initiates a control action relating to audio conversation within the group of users in response to one or more user control inputs at the respective selectable region.

5. The system of claim 4, wherein the control action includes one or more of starting a conversation, joining a conversation, or adding to the conversation.

6. The system of claim 4, wherein the control action includes one or more of making a conversation private or leaving a conversation.

7. The system of claim 4, wherein the control action includes one or more of muting a conversation, changing a user volume, muting a background conversation, or changing a background conversation volume.

8. The system of claim 4, wherein the control action includes opening or closing a conversation.

9. The system of claim 8, wherein the connect cluster UI element includes a graphical indication of a door in either an open or closed configuration to represent an open or closed door respectively such that a user having an open door or by default may overhear other conversations and receive an associated audio stream or a user having a closed door may not overhear other conversations and not receive an associated audio stream unless a knock input is answered affirmatively.

10. The system of claim 2, wherein the cluster of selectable regions comprises a circular grouping of selectable regions about a central point, and each selectable region further comprises a circular shape.

11. The system of claim 10, wherein the group of users comprise a predetermined team of users, and the connect cluster controller initiates a control action relating to audio conversation within the team of users in response to one or more user control inputs at the respective selectable region.

12. The system of claim 11, wherein the connect cluster UI element further includes a control region at the central point that enables a user to input a control action.

13. The system of claim 1, wherein the connect cluster controller further enables a user to move the connect cluster UI element within a display view.

14. The system of claim 1, wherein the connect cluster controller further enables a user to select a menu of settings or input hotkey commands, and wherein the menu of settings include control actions to open or close a door to an audio conversation within the group of users, to set device or audio options, and the hotkey commands include control actions to to open or close a door to an audio conversation within the group of users, connect with a teammate, or end a conversation.

15. The system of claim 4, wherein the connect cluster controller sends a control signal representative of the control action to the collaboration manager, and the collaboration manager manages the audio conversation within the group of users according to the received control action.

16. The system of claim 15, wherein the control action includes one or more of starting a conversation, joining a conversation, or adding to the conversation, and the collaboration manager initiates audio stream connections within the group of users to start the conversation, join the conversation, or add to the conversation in accordance with the respective control action and users identified based on user inputs at the connect cluster user-interface (UI) element.

17. The system of claim 15, wherein the control action includes one or more of making a conversation private or leaving a conversation, and the collaboration manager initiates or manages audio stream connections within the group of users to make a conversation private between users or have a user leave a conversation in accordance with the respective control action and users identified based on user inputs at the connect cluster user-interface (UI) element.

18. The system of claim 15, wherein the control action includes one or more of one or more of muting a conversation, changing a user volume, muting a background conversation, or changing a background conversation volume, and the collaboration manager manages audio stream connections within the group of users in accordance with the respective control action and users identified based on user inputs at the connect cluster user-interface (UI) element.

19. The system of claim 15, wherein the control action includes one or more of one or more of opening or closing a conversation, and the collaboration manager manages audio stream connections within the group of users in accordance with the respective control action and users identified based on user inputs at the connect cluster user-interface (UI) element.

20. The system of claim 19, wherein the application further comprises a connection manager coupled to the connect cluster controller and configured to control connections between one or more remote computing devices for audio streams corresponding to a conversation in which the user participates.

21. An audio-based collaboration system for a team of users comprising:
a collaboration manager implemented on one or more processors and configured to communicate with remote applications over a data network; and
a database coupled to the collaboration manager for storing data data relating to the online audio collaboration managed by collaboration manager;
wherein the collaboration manager is configured to manage collaboration between groups of users in a team, and to communicate with a remote application configured to enable a user to control online audio collaboration between other users in the group including which conversation in the group of users the user wishes to participate in accordance with one or more control inputs selected by the user on a connect cluster UI element through a user-interface.

22. A computer-implemented method for dynamically enabling a group of users to control participation in online audio conversations through control inputs at user interfaces comprising:
determining initial state information about current conversations between users in the group;
displaying a connect cluster user-interface (UI) element in a display view in an initial configuration corresponding to the determined initial state information;
enabling a user to select through a user-interface one or more control inputs using the connect cluster UI element; and
connecting audio streams between a device of the user and devices of other users and updating state information according to the selected control inputs.

23. The method of claim 22, further comprising:
dynamically configuring the connect cluster user-interface (UI) element in an updated configuration according to the selected control inputs or updated state information.

24. The method of claim 23, wherein the dynamically configuring includes displaying the connect cluster UI element according to a number of users in the group, online presence status, and updating selectable control actions.

25. The method of claim 22, further comprising notifying a collaboration manager of online audio collaboration activity.

26. A non-transitory computer-readable storage device having instructions stored thereon that, when executed by at least one processor, causes the at least one processor to perform operations for enabling a group of users to control participation in online audio conversations through control inputs at user interfaces, wherein the operations comprise:
determining initial state information about current conversations between users in the group;
displaying a connect cluster user-interface (UI) element in a display view in an initial configuration corresponding to the determined initial state information;
enabling a user to select through a user-interface one or more control inputs using the connect cluster UI element; and
initiating connecting of audio streams between a device of the user and devices of other users and updating state information according to the selected control inputs.
